(19) United States
(12) Patent Application Publication
(10) Pub. No.: US 2005/0160444 A1
(43) Pub. Date: Jul. 21, 2005

(54) Optical disc storage device with adhesive capability

(75) Inventor: Lee-Ting Chen, Sanchong City (TW)

Correspondence Address: BACON & THOMAS, PLLC, 625 SLATERS LANE, FOURTH FLOOR, ALEXANDRIA, VA, 22314, US

(73) Assignee: Mei-Ling CHANG, Chung Li City (TW)

(21) Appl. No.: 10/859,236

(22) Filed: Jun. 3, 2004

(30) Foreign Application Priority Data
Jan. 20, 2004 (TW) 093101563

(51) Int. Cl. G11B 23/03; B65D 85/30; B65D 85/57

(52) U.S. Cl. 720/728; 206/308.1

(57) ABSTRACT

The present invention discloses an optical disc storage device which comprises an upper and a lower casings of the size and shape allowing them to be assembled together and form an space for accommodating at least one optical disc; at least one protrusion disposed on an inner side of any of the two casings, such that the diameter of the protrusion restricts a positioning hole of the optical disc at the outer edge of the protrusion; a magnetic component disposed adjacent to the center of the protrusion, so that the optical disc storage device can be attached securely onto metal panel of any appliances, such as a refrigerator, an office appliance or a white board, by the action of the magnetic component for exhibitions and easy accesses, which also enables several optical disc storage devices to be adhered together and stacked or aligned neatly together for a convenient storage.

### BACKGROUND OF THE INVENTION

1. Field of the Invention

The present invention relates to optical disc storage devices, more particularly to an optical disc storage device with an adhesive capability.

2. Description of the Related Art

In recent years, various optical discs (such as CD and DVD, etc) are introduced to the market. Since these optical discs feature a high storage capacity, easy-to-store and uneasy to be damaged by moisture, therefore they are welcome by the industry and consumers and used extensively for storing various videos, music and information. The optical discs gradually take over the position of the traditional floppy discs and become the trend of a mainstream storage medium. The present popular standard specifications for optical discs are taken for example; the diameter is about 12 cm; the thickness is about 1 mm; the storage capacity is about 650˜750 MB for CDs and 7˜8 GB for DVDs. Traditional devices for containing and storing these optical discs are usually made of a hard plastic material and generally called a compact disc holder 10. Please refer to FIG. 1 for the optical disc holder 10 which comprises an upper casing 11 and a lower casing 12. One side of these two casings 11, 12 is pivotally coupled and an accommodating space is enclosed by these casings 11, 12 for storing an optical disc 13. A resilient embedding member 14 protruded from an inner side of the lower casing 12 has a size precisely fitting into a positioning hole disposed at the center of the optical disc 13, so that the optical disc 13 can be fixed onto the inner side of the lower casing 12. Although such optical disc holder 10 is a common optical disc storage device, yet its size is large with a length of about 14.3 cm, a width of about 12.2 cm and a thickness of about 1 cm, and thus occupying a larger storage space. Since such optical disc holder 13 is made of a hard and brittle material, the housing will crack or the pivotal connection structure between two casings 11, 12 breaks very easily, if the optical disc holder 10 is collided or falls off onto the ground. The broken optical disc holder 10 is no longer usable or the casings cannot be closed for protecting the optical disc 10 stored therein.

In view of the foregoing shortcomings, some manufacturers design such optical disc storage device as an insertion-type optical disc holder 20 as shown in FIG. 2. The optical disc holder 20 is a closed housing made of a plastic material, and a long slot 22 is disposed on an edge of the housing for inserting an optical disc 23 and accommodating and positioning the optical disc 23 in an accommodating space under the restriction of a resilient component 24. Although such device can save the foregoing pivotal connection assembly and simplify its structure and operation, the storage method requires users to insert the optical disc 23 into the long slot 22 of the optical disc holder 20 and thus it is necessary to keep a gap T between two corresponding inner sidewalls of the optical disc holder 20 in order to prevent the surface of the optical disc 23 from being scraped or damaged when it is inserted into the optical disc holder 20. Therefore, such design cannot effectively reduce the thickness of the optical disc storage device.

Further, after the writeable and duplicable optical discs are introduced in recent years, people use these optical discs for storing huge information such as images, music and data for different applications. For example, a multimedia production program is used to produce the clippings of the personal life of related parties together with dialogues and background music for special occasions such as anniversaries, birthdays, sports days, alumni and product announcement presentations. Sending an optical disc with audio and video information to relatives and friends as a gift or a souvenir has become a modern way of giving memorable gifts. Therefore, the way of designing a compact, simple, easy-to-operate, easy-to-store and convenient-to-display optical disc storage holder is an important topic and objective of the present invention.

### SUMMARY OF THE INVENTION

The primary objective of the present invention is to provide an optical disc storage device with an adhesive capability. The optical disc storage device comprises an upper casing and a lower casing, and the size and shape of these two casings allows them to be assembled together and form an accommodating space for accommodating at least one optical disc; at least one protrusion disposed on an inner side of any of the two casings, such that the diameter of the protrusion restricts a positioning hole disposed at the center of the optical disc at the outer edge of the protrusion; a magnetic component disposed adjacent to the center of the protrusion, so that the optical disc storage device can be attached securely onto any metal panel made of a material with a magnetic permeability such as a refrigerator, an office appliance or a white board by the action of the magnetic component for exhibitions and easy accesses. Such arrangement also can attach several optical disc storage devices together and stack or align the optical disc storage devices neatly together for a convenient storage.

Another objective of the present invention is to install another metal plate or magnetic component made of a magnetic material onto one of the two casings that does not have the protrusion at a position corresponding to the protrusion, so that when the two casings are engaged as a whole, the magnetic component attaches onto the metal plate or another magnetic component. Therefore, the two casings can be engaged closely together without requiring other latch components, and thus effectively simplifying the assembling structure and operation of the optical disc storage device.

A further objective of the present invention is to install at least one corresponding latch component on the periphery of the two casings, such that when the two casings are engaged, the corresponding latch components can be engaged with each other while the magnetic component is attached onto the metal plate or another magnetic component; and the two casings can be connected closely with each other into a whole by the latch component, and also make the closing and opening of the optical disc storage device easier and smoother.

Another further objective of the present invention is to install at least one positioning plate between the two casings, and one side of the positioning plate is connected to one side of the two casings. After the two casings are engaged, each positioning plate is accommodated in the accommodating space enclosed by the two casings. Each positioning plate has at least one protrusion protruded from an inner side of the positioning plate, and the diameter of the protrusion restricts a positioning hole disposed at the center of an optical disc at the outer periphery of the protrusion. A magnetic component is installed adjacent to the center of the protrusion. Therefore, the adjacent casings and the positioning plates (or adjacent positioning plates) can be attached together by the action of the magnetic component, such that the optical disc is restricted between the adjacent casings and positioning plates (or adjacent positioning plates), and the optical disc will not fall off from the protrusion easily.

The above and other objects, features and advantages of the present invention will become apparent from the following detailed description taken with the accompanying drawings.

### BRIEF DESCRIPTION OF THE DRAWINGS

FIG. 1 is a perspective view of the prior-art optical disc holder.

FIG. 2 is another perspective view of the prior-art optical disc holder.

FIG. 3 is a perspective view of the structure of the optical disc storage device according to a first preferred embodiment of the present invention.

FIG. 4 is a perspective view of the optical disc storage device being in use as depicted in FIG. 3.

FIG. 5 is another perspective view of the optical disc storage device being in use as depicted in FIG. 3.

FIG. 6 is a further perspective view of the optical disc storage device being in use as depicted in FIG. 3.

FIG. 7 is a cross-sectional view of the optical disc storage device according to a second preferred embodiment of the present invention.

FIG. 8 is a perspective view of the optical disc storage device being opened according to a third preferred embodiment of the present invention.

FIG. 9 is a perspective view of the optical disc storage device as depicted in FIG. 8 when optical disc storage device is closed.

FIG. 10 is a cross-sectional view of the optical disc storage device as depicted in FIG. 8 when the optical disc storage device is closed.

FIG. 11 is a side view of the optical disc storage device as depicted in FIG. 8 when the optical disc storage device is closed.

FIG. 12 is a cross-sectional view of the optical disc storage device according to a fourth preferred embodiment of the present invention.

FIG. 13 is a cross-sectional view of the optical disc storage device according to a fifth preferred embodiment of the present invention.

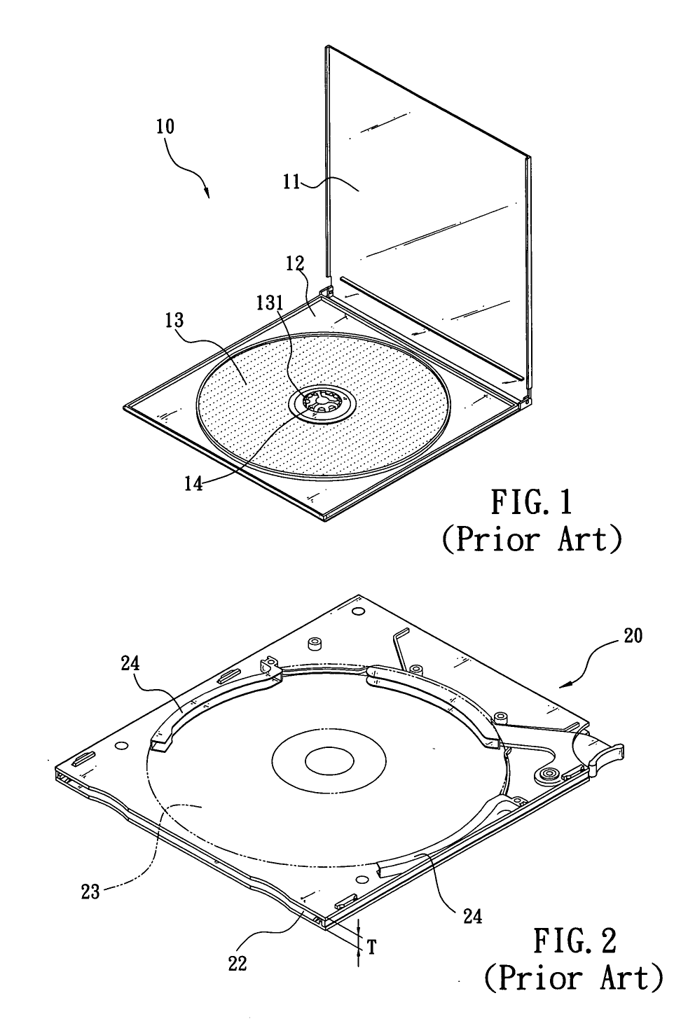

### DETAILED DESCRIPTION OF THE PREFERRED EMBODIMENTS

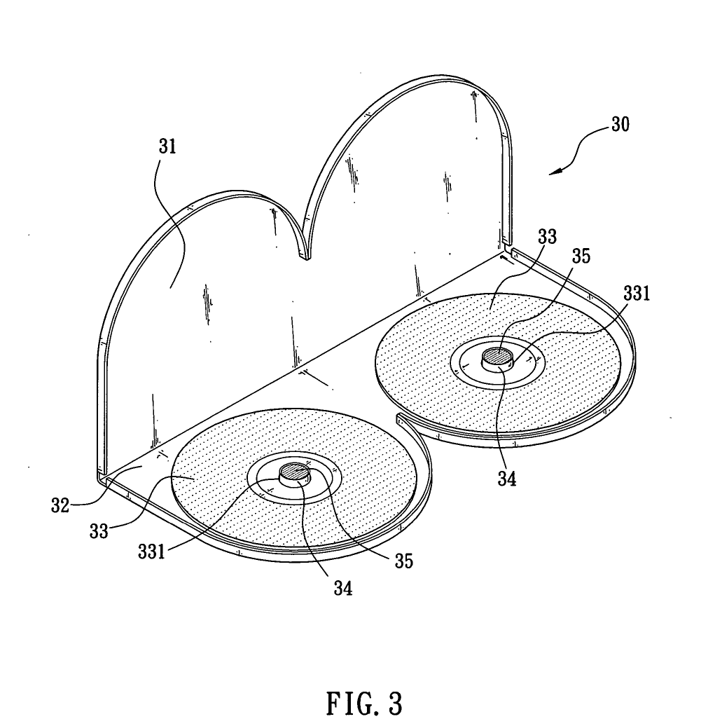

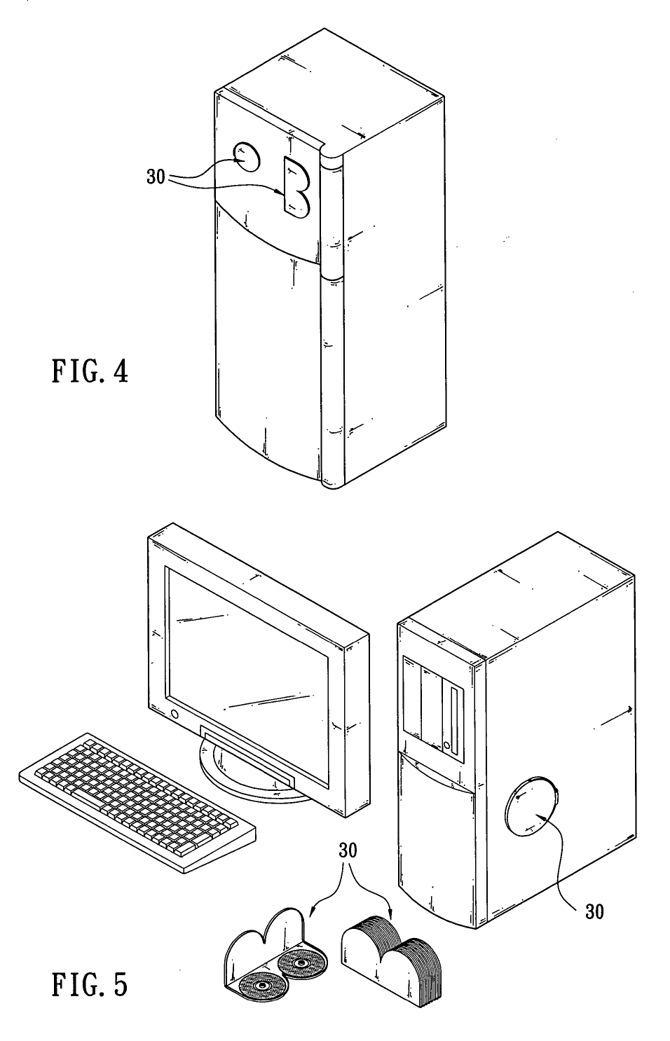

Please refer to FIG. 3 for an optical disc storage device with an adhesive capability according to the first preferred embodiment of the present invention. The optical disc storage device 30 comprises an upper casing 31 and a lower casing 32, and the two casings 31, 32 have the size and shape precisely fit for engaging with each other and forming an accommodating space in between them for storing at least one optical disc 33 after the two casings 31, 32 are engaged. In the first preferred embodiment, two optical discs stored into the optical disc storage device are used as an example for the illustration. A protrusion 34 is disposed on the inner side of the lower casing 32 at the position of a positioning hole corresponding to the center of each optical disc 33, and the diameter of the protrusion 34 can fix the positioning hole of the optical disc 33 precisely at the outer periphery of the protrusion. A magnetic component 35 is installed adjacent to the center position of the protrusion 34, such that the magnetic component 35 can attach the optical disc storage device 30 securely onto any metal panel made of a material having a magnetic permeability. Therefore, the optical disc storage device 30 according to the present invention can be fixed and positioned freely onto the metal panel of a refrigerator or a computer system etc. for being displayed and exhibited or for easy access, as shown in FIGS. 4 and 5. Please refer to FIG. 5 again, the optical disc storage devices 30 can also be mutually adhered, or neatly stacked or aligned with each other on a table for being stored and arranged conveniently.

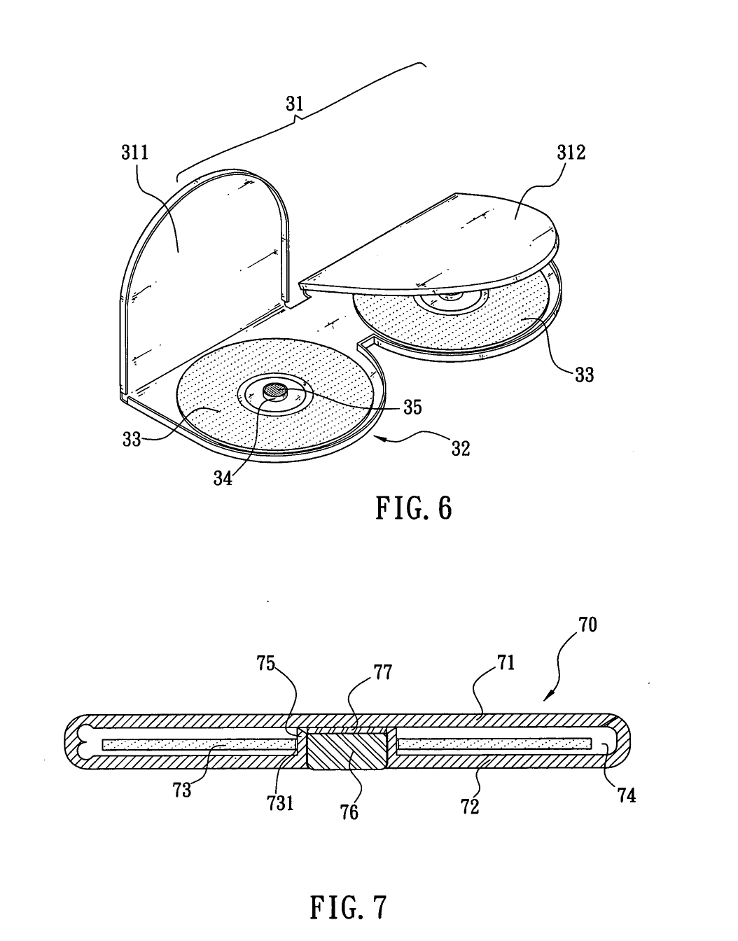

Please refer to FIG. 3 again for a first preferred embodiment of the present invention. The two casings 31, 32 are formed integrally and have one side coupled with each other, so that the two casings can be opened or closed. However, such arrangement is not limited by the embodiment, and those skilled in the art can separate the two casings or divide the upper casing 31 into corresponding sub-casings 311, 312 for protecting the corresponding optical discs. Please refer to FIG. 6. As long as the size and shape of the two casings 31, 32 fit for their engagement and has the foregoing accommodating space, protrusion 34 and magnetic component 35 for storing at least one optical disc 33, the optical disc storage devices of this sort fall into the scope of the present invention.

Please refer to FIG. 7 for the optical disc storage device 70 according to a second preferred embodiment of the present invention. The optical disc storage device 70 comprises an upper casing 71 and a lower casing 72, and the two casings 71, 72 have the size and shape precisely fit for engaging with each other and forming an accommodating space 74 in between them for storing at least one optical disc 33 after the two casings 71, 72 are engaged. A protrusion 75 is disposed on the inner side of the lower casing 72 at the position of a positioning hole 731 corresponding to the center of each optical disc 33, and the diameter of the protrusion 75 can fix the positioning hole 731 of the optical disc 33 precisely at the outer periphery of the protrusion 75. A magnetic component 76 is installed adjacent to the center position of the protrusion 75, and a metal plate made of a material having a magnetic permeability (or another magnetic component) 77 is installed on the upper casing 71 at a position corresponding to the protrusion 75 such that the magnetic component 76 of the lower casing 72 can attach onto the metal plate (or another magnetic component) 77 of the upper casing 71. Therefore, under the condition not necessary to install any latch components on the two casings 71, 72, it is still able to securely engage the two casings 71, 72 and effectively simplify the assembly, structure and operation of the optical disc storage device.

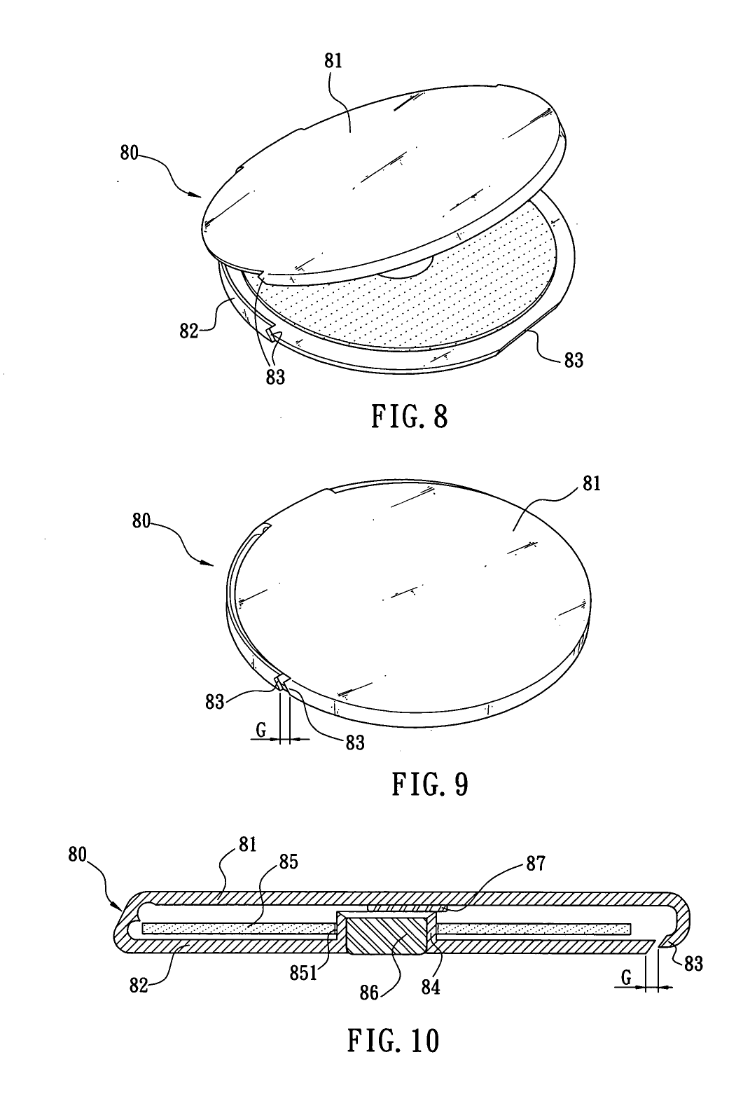

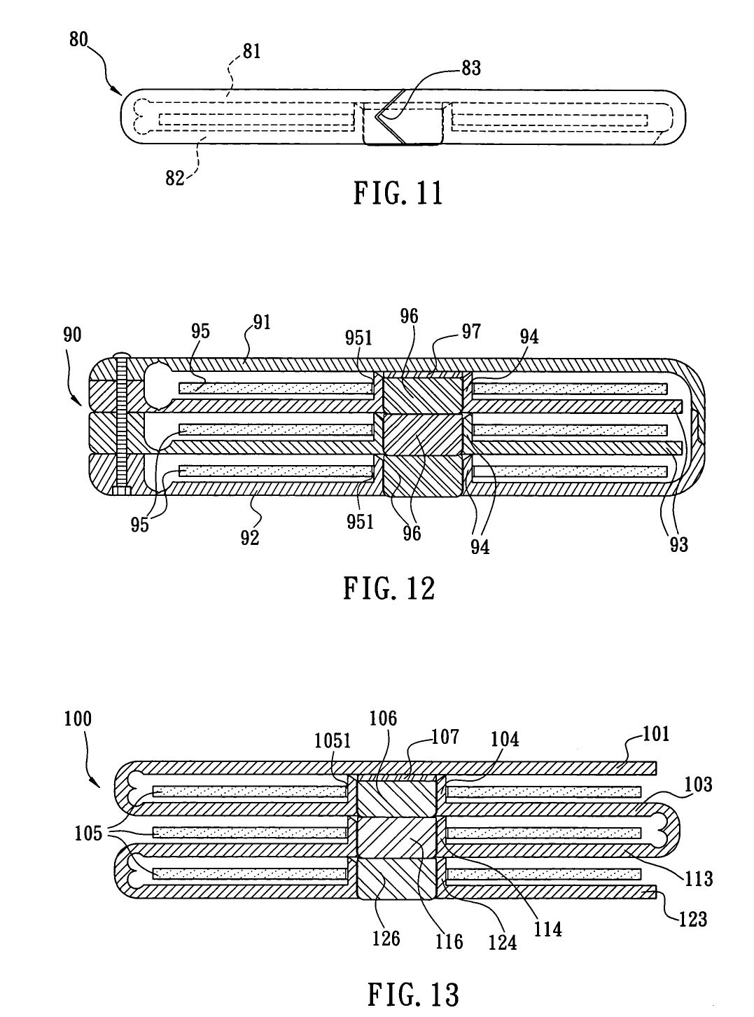

Please refer to FIGS. 8 and 9 for the optical disc storage device 80 according to a third preferred embodiment of the present invention. The optical disc storage device 80 comprises an upper casing 81, a lower casing 82, and at least one mutually embedded corresponding latch component 83 disposed at the periphery of the two casings 81, 82. This embodiment adopts three mutually embedded corresponding latch components 83 as an example for the illustration. At least one protrusion 84 is protruded from the inner side of the lower casing 82, and the diameter of the protrusion 84 fixes a positioning hole 851 disposed at the center of an optical disc 85 at the external periphery of the protrusion 84. A magnetic component 86 is installed adjacent to the center position of the protrusion 84, and a metal plate made of a material having a magnetic permeability (or another magnetic component) 87 on the upper casing 81 at the position corresponding to the protrusion 84, such that when the two casings 81, 82 are engaged as shown in FIGS. 9 and 10, the upper casing 81 is pushed towards the lower casing 82 with a bias shift, and the latch component 83 of the upper casing 81 is embedded into the corresponding position of the latch component 83 of the lower casing 82 with an appropriate gap G in between. In the meantime, since the center position of the magnetic component 86 of the lower casing 82 has a bias shift with respect to the metal plate (or another magnetic component) 87 of the upper casing 81, therefore when the magnetic component 86 adheres the metal plate (or another magnetic component) 87 to engage the two casings 81, 82 as a whole, the three corresponding latch components 83 at the periphery of the two casings 81, 82 are embedded with each other as shown in FIG. 11, so that the two casings 81, 82 can be coupled more securely as a whole by the latch components 83 and makes the operations of opening or closing the optical disc storage device 80 easier and smoother.

Please refer to FIG. 12 for the optical disc storage device 90 according to a fourth preferred embodiment of the present invention. The optical disc storage device 90 comprises an upper casing 91, at least one positioning plate 93 having an adhesive capability and a lower casing 92, and one side of the two casings 91, 92 is coupled to one side of the positioning plate 93, such that when the two casings are engaged, the positioning plate 93 is accommodated precisely into an accommodating space formed between the two casings 91, 92. The fourth preferred embodiment adopts two positioning plates 93 as an example for the illustration, wherein each positioning plate 93 has at least one protrusion 94 protruded from an inner side, and the diameter of the protrusion 94 fixes a positioning hole 951 disposed at the center of an optical disc 95 at the external periphery of the protrusion 94. A magnetic component 96 is installed adjacent to the center position of the protrusion 94. Therefore, the adjacent casings 91, 92 and the positioning plates 93 (or adjacent positioning plates) can be attached together by the action of the magnetic component 96, such that the optical disc 95 is restricted between the adjacent casings 91, 92 and positioning plates 93 (or adjacent positioning plates), and the optical disc 95 will not fall off easily from the protrusion.

Please refer to FIG. 12 for the fourth preferred embodiment again. The lower casing 92 also has at least one protrusion 94 at its inner side, and the diameter of the protrusion 94 fixes a positioning hole 951 disposed at the center of an optical disc 95 at the external periphery of the protrusion 94. A magnetic component 96 is installed adjacent to the center position of the protrusion 94, such that the lower casing 92 and the adjacent positioning plate 93 can be securely attached together by the action of the magnetic components 96. The position of the inner side of the upper casing 91 corresponding to the protrusion 94 disposed on the adjacent positioning plate 93 can fix a metal plate made of a material having a magnetic permeability (or another magnetic component 97), so that when the upper casing 91 is engaged with the lower casing 92, the upper casing 91 is adhered and engaged with the lower casing 92 by the magnetic effect of the magnetic component 96.

Please refer to FIG. 13 for an optical disc storage device 100 according to a fifth preferred embodiment of the present invention. The optical disc storage device 100 comprises an upper casing 101, at least two positioning plates 103 having an adhesive capability. The fifth preferred embodiment adopts three positioning plates 103 as an example for the illustration. One side of the upper casing 101 is coupled with one side of a first positioning plate 103, such that the upper casing 101 is engaged precisely onto the first positioning plate 103 and form an accommodating space in between. At least one protrusion 104 is protruded from the first positioning plate 103 on the side facing the upper casing 101, and the diameter of the protrusion 104 fixes a positioning hole 1051 disposed at the center of an optical disc 105 at the external periphery of the protrusion 104. A magnetic component 106 is installed adjacent to the center position of the protrusion 104, and a metal plate 107 made of a material having a magnetic permeability (or another magnetic component) is fixed on the inner side of the upper casing 101 at the position corresponding to the protrusion 104 of the first positioning plate 103, such that when the upper casing 101 is engaged with the first positioning plate 103, the upper casing 101 is adhered and engaged with the first positioning plate 103 by the magnetic effect of the magnetic component 106. Another side of the first positioning plate 103 is coupled with a side of a second positioning plate 113, and the first positioning plate 103 is engaged precisely onto the second positioning plate 113 and an accommodating space is formed in between. At least one protrusion 114 is protruded from the second positioning plate 113 at the side facing the first positioning plate 103 and the diameter of the protrusion 114 fixes a positioning hole 1051 disposed at the center of an optical disc 105 at the outer periphery of the protrusion 114 and a magnetic component 116 is installed adjacent to the center of the protrusion 114, such that when the first positioning plate 103 is engaged with the second positioning plate 113, the magnetic components 106, 116 are attracted to each other to engage the two successfully. Another side of the second positioning plate 113 is coupled with a side of a third positioning plate 123, and the second positioning plate 113 is engaged precisely with the third positioning plate 123 to form an accommodating space in between. At least one protrusion 124 is protruded from the third positioning plate 123 at a side facing the second positioning plate 113, and the diameter of the protrusion 124 can fix a positioning hole 1051 disposed at the center of an optical disc 105 at the outer periphery of the protrusion 124, and a magnetic component 126 is installed adjacent to the center of the protrusion 124, so that when the second positioning plate 113 is engaged with the third positioning plate 123, the two positioning plates are engaged as a whole due to the mutual attraction of the magnetic components 116, 126. Since the adjacent positioning plates according to the fifth preferred embodiment can fix each optical disc by means of the mutual attraction of the magnetic components, the optical disc will not fall off easily from the protrusion.

In the fifth preferred embodiment, the upper casing 101 and each positioning plate 103, 113, 123 individually comprises at least one mutually embedded corresponding latch component (not shown in the figure) at its periphery, and the latch component on the upper casing 101 or each positioning plate 103, 113, 123 is shifted to the position mutually engaged with the corresponding latch component of the adjacent positioning plate when a force is exerted on the corresponding casing or positioning plate to produce a bias shift. Then, since the center position of the metal plate 107 of the upper casing 101 has a bias shift with respect to the center position of the magnetic component 106 of the first positioning plate 103 or the center position of the magnetic component of the adjacent positioning plate, therefore when the magnetic component is aligned and attached to the metal plate or the adjacent magnetic component as a whole, the mutually embedded corresponding latch components at their periphery are mutually engaged.

It is noteworthy that the design position and quantity of the magnetic components and metal plates described in the foregoing preferred embodiment can be changed or modified according to the actual need. However, no matter what changes or modifications are made, it will still fall into the scope of the claims as long as the magnetic components and metal plates are disposed adjacent to the protrusion and its corresponding position such that the adjacent casings, or adjacent casing and positioning plate or adjacent positioning plates are adhered with each other due to the magnetic force.

While the invention has been described by means of specific embodiments, numerous modifications and variations could be made thereto by those skilled in the art without departing from the scope and spirit of the invention set forth in the claims.

1. An optical disc storage device with adhesive capacity, comprising:
an upper casing;
a lower casing, engaging with said upper casing and forming an accommodating space between said upper and lower casings for storing at least one optical disc;
a protrusion, protruded from a positioning hole disposed on the inner side at a position corresponding to said each optical disc, such that the diameter of said protrusion fixing said positioning hole of said optical disc on the outer periphery of said protrusion; and
a magnetic component, disposed adjacent to the center position of said protrusion.

2. The optical disc storage device of claim 1, wherein said upper casing comprises a metal plate made of a material having a magnetic permeability at a position corresponding to said each protrusion, such that when said two casings are engaged, said magnetic component is adhered onto said metal plate.

3. The optical disc storage device of claim 2, wherein said upper and lower casings individually have at least one mutually embedded corresponding latch component at their periphery.

4. The optical disc storage device of claim 3, wherein said optical disc storage device is integrally formed and said upper and lower casings are coupled together at one side.

5. The optical disc storage device of claim 4, wherein said lower casing has a bias shift when said upper casing is engaged with said lower casing, and said each latch component of said upper casing shifts to the corresponding position of said each latch component on said lower casing and keeps an appropriate gap between said latch components, and a bias shift occurs between the center position of said magnetic component of said lower casing and the center position of said metal plate of said upper casing, such that when said magnetic component attaches onto said metal plate, said two casing engage with each other and said corresponding latch component engage with each other.

6. The optical disc storage device of claim 5, wherein said upper casing further comprises at least one sub-casing for protecting said each optical disc.

7. The optical disc storage device of claim 5, wherein said metal plate is another magnetic component.

8. An optical disc storage device with adhesive capacity, comprising:
an upper casing;
a lower casing, having a size and a shape precisely fitting for engaging with each other;
at least one positioning plate, being disposed between said upper casing and lower casing, and one side of said positioning plate being coupled with one side of said upper and lower casings, such that an accommodating space being formed by said upper and lower casings after said upper and lower casing being engaged with each other, and said positioning plate comprising at least one protrusion disposed on the inner side of said positioning plate and the diameter of said protrusion fixing a positioning hole disposed at the center of an optical disc on the outer periphery of said protrusion and a magnetic component disposed adjacent to the center position of said protrusion.

9. The optical disc storage device of claim 8, wherein said upper casing comprises a metal plate being made of a magnetic permeable material and disposed at the inner side of said upper casing at a position corresponding to the center position of said protrusion of said positioning plate.

10. The optical disc storage device of claim 9, wherein said lower casing comprises at least one other protrusion at the inner side of said lower casing, and the diameter of said other protrusion fixes a positioning hole disposed at the center of an optical disc at the outer periphery of said protrusion, and a magnetic component disposed adjacent to the center position of said other protrusion.

11. The optical disc storage device of claim 10, wherein said upper casing and lower casing individually comprises at least one mutually embedded corresponding latch component at their periphery.

12. An optical disc positioning plate with adhesive capacity, comprising:
at least one protrusion disposed on one side of said positioning plate, and the diameter of said protrusion fixing a positioning hole disposed at the center of an optical disc precisely onto the outer periphery of said protrusion; and
a magnetic component, disposed adjacent to the center position of said protrusion.

13. An optical disc storage device with adhesive capability, comprising:
an upper casing;
at least two positioning plates; wherein one side of said one positioning plate being coupled to one side of said upper casing, such that said upper casing being engaged precisely onto said positioning plate and forming an accommodating space in between; at least one protrusion being protruded from said positioning plate on a side facing said upper casing, and the diameter of said protrusion fixing a positioning hole disposed at the center of an optical disc at the outer periphery of said positioning plate; a magnetic component being disposed adjacent to the center position of said protrusion; and another side of said positioning plate being coupled to one side of another positioning plate, such that said positioning plate being engaged precisely onto said other positioning plate and forming an accommodating space; at least one other protrusion, being protruded form said other positioning plate on a side facing said positioning plate, and the diameter of said other protrusion fixing a positioning hole disposed at the center of an optical disc onto the outer periphery of said other protrusion; and another magnetic component, being disposed adjacent to the center position of another protrusion.

14. The optical disc storage device of claim 13, wherein said upper casing at its inner side comprises a metal plate made of a magnetic permeable material, such that when said upper casing engages with said positioning plate, said magnetic component adheres onto said metal plate.

15. The optical disc storage device of claim 13, wherein said upper casing and said positioning plate individually comprises at least one mutually embedded corresponding latch component at their periphery.

16. The optical disc storage device of claim 14, wherein said adjacent positioning plate comprises at least one mutually embedded corresponding latch component at its periphery.

17. The optical disc storage device of claim 15, wherein said positioning plate has a bias shift when said upper casing engages with said positioning plate, and said each latch component of said upper casing shifts to a position corresponding to said each latch component of said positioning plate, and keeps an appropriate gap between said corresponding latch components, and a bias shift occurs between the center position of said magnetic component of said positioning plate and the center position of said metal plate of said upper casing, and when said magnetic component attaches onto said metal plate, said magnetic component and said metal plate are engaged integrally and said corresponding latch components are mutually embedded.

18. The optical disc storage device of claim 16, wherein said bias shift occurs at another positioning plate when said positioning plate is engaged onto another positioning plate, and said each latch component of said positioning plate shifts to a position corresponding to said each latch component of said other positioning plate, and keeps an appropriate gap between said corresponding latch components, and a bias shift occurs at the center position of said each magnetic component of said positioning plate and when said magnetic components attract to each other, said each positioning plate is aligned and engaged integrally, and said corresponding latch components are mutually embedded.
